(19) United States
(12) Patent Application Publication
(10) Pub. No.: US 2026/0126850 A1
(43) Pub. Date: May 7, 2026

(54) METHODS AND SYSTEMS FOR HAND MICRO-GESTURE RECOGNITION FOR A VISUAL SEE THROUGH DEVICE

(71) Applicant: Samsung Electronics Co., Ltd., Suwon-si (KR)

(72) Inventors: Vishakha SETTISARA RATNAKAR, Bengaluru (IN); Green Rosh KUMBALAPARAMBIL SREEDHARAN, Bengaluru (IN); Pawan Prasad BINDIGAN HARIPRASANNA, Bengaluru (IN); Meghana SHANKAR, Bengaluru (IN); Sungsoo CHOI, Suwon-si (KR); Hyuntaek WOO, Suwon-si (KR)

(21) Appl. No.: 19/377,514

(22) Filed: Nov. 3, 2025

Related U.S. Application Data
(63) Continuation of application No. PCT/KR2025/013012, filed on Aug. 26, 2025.

(30) Foreign Application Priority Data
Nov. 5, 2024 (IN) 202441084666

(51) Int. Cl. G06F 3/01; G06F 3/04815; G06F 3/04842; G06V 40/20

(52) U.S. Cl. CPC G06F 3/011; G06F 3/017; G06F 3/04815; G06F 3/04842; G06V 40/28

(57) ABSTRACT

Methods and systems for hand micro-gesture recognition for a visual see through (VST) device are provided. The system includes a hand velocity estimation module configured to determine a hand velocity of a movement of a hand of a user using hand images being captured by the VST device, a jitter module configured to determine an average jitter associated with the movement of the hand, an upscaling module configured to determine, based on the hand velocity and the average jitter, an upscaling factor for generating high-resolution hand images corresponding to the captured one or more hand images, a key-point module configured to measure, using the generated high-resolution hand images, a movement of a plurality of hand key-points associated with the hand, and a gesture recognition module configured to recognize, based on a comparison of the measured movement of the plurality of hand key-points and the determined average jitter, the movement of the plurality of hand key-points as a hand micro-gesture.

### CROSS-REFERENCE TO RELATED APPLICATION(S)

This application is a continuation application, claiming priority under 35 U.S.C. § 365(c), of an International application No. PCT/KR2025/013012, filed on Aug. 26, 2025, which is based on and claims the benefit of an Indian Patent Application number 202441084666, filed on Nov. 5, 2024, in the Indian Patent Office, the disclosure of which is incorporated by reference herein in its entirety.

### BACKGROUND

### 1. Field

The disclosure relates to the field of Visual See Through (VST) devices. More particularly, the disclosure relates to a method and a system for micro-gesture recognition in VST devices.

### 2. Description of Related Art

A visual see through (VST) device is an electronic display device that allows the user to see what is shown on the screen while still being able to see through the screen. Examples of VST devices include head-up displays, augmented reality systems, and the like. The VST device may be a head mounted display (HMD) device. The VST device may be mounted on a user's forehead covering the eyes of the user. The VST device includes a display/digital screen between the real world and the eyes of the user. The screen is a see-through screen and may be placed very close to the eyes of the user as shown in FIG. 1, according to the related art.

FIG. 1 illustrates a scenario depicting a real-world scene being captured using a visual see through (VST) device according to the related art.

Referring to FIG. 1, a scenario 100 depicting a real-world scene 100S being captured using a visual see through (VST) device 150 is illustrated. The real-world scene 100S may be captured in the form of images or series of images, and the like and rendered on a screen of the device 150. The VST device 150 gives viewers a more immersive viewing experience via a pass-through mode of the VST device 150. In the pass-through mode, the user is able to see the real world in real-time while wearing the VST device 150. For a delightful user experience, the pass-through mode of the VST device 150 should be able to mimic the pair of human eyes as closely as possible. To realize the pass-through mode, the VST device 150 has a transparent display and includes a pair of cameras depicting each eye of the pair of eyes of a human being. The two cameras capture a scene of the real-world and project the scene on the transparent display of the VST device 150 in real-time.

The pass-through mode of the VST device 150 may be enabled in various scenarios, such as a mixed reality scenario. In the mixed reality scenario, the attention of the user is more focused on the virtual content. The pass-through mode may be enabled during an augmented reality (AR) scenario, wherein the user has his/her full attention on the AR content. For interacting with the VST device 150, the user may need to input certain commands into the VST device 150 and may use hand gestures for the same.

Hand gestures are the primary mode of interaction while using the HMDs. These hand gestures with minimal hand movements are called micro-gestures. Examples of micro-gestures include pinching/closing fingers, rotating fingers clockwise, snapping fingers, opening fingers, rotating fingers anti-clockwise, and the like.

FIG. 2 illustrates micro-gestures according to the related art.

Referring to FIG. 2, the HMDs should be able to detect and recognize these micro-gestures with accuracy. However, the range of motion for the micro-gestures is very small. Typically, a jitter in the hand or the tracking device/system hinders an accurate detection of the micro-gesture.

There have been attempts to provide for methods which try to overcome the problem of jitter while detecting micro-gestures by comparing a movement of the hand in the images of the hand to a predefined movement within a fixed period of time. Another current method includes cropping the images of the hand and applying fixed tolerances to segregate jitter from actual micro-gestures. Such methods use fixed time frame and fixed movement of the hand for comparison and are not able to detect the micro gestures accurately.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a system for micro-gesture recognition in VST devices.

Additional aspects will be set forth in part in the description which follows and, in part, will be apparent from the description, or may be learned by practice of the presented embodiments.

In accordance with an aspect of the disclosure, a method for hand micro-gesture recognition for a visual see through (VST) device is provided. The method includes determining a hand velocity of a movement of a hand of a user using one or more hand images being captured by the VST device, determining an average jitter associated with the movement of the hand in the one or more hand images, determining, based on the hand velocity and the average jitter, an upscaling factor to generate high-resolution hand images corresponding to the captured one or more hand images, generating high-resolution hand images by increasing, as per the upscaling factor, a resolution of the corresponding captured one or more hand images, measuring, using the generated high-resolution hand images, a movement of a plurality of hand key-points associated with the hand, recognizing, based on a comparison of the measured movement of the plurality of hand key-points and the determined average jitter, the movement of the plurality of hand key-points as a hand micro-gesture.

In accordance with another aspect of the disclosure, a system for hand micro-gesture recognition for a visual see through (VST) device is provided. The system includes a hand velocity estimation module configured to determine a hand velocity of a movement of a hand of a user using one or more hand images being captured by the VST device, a jitter module configured to determine an average jitter associated with the movement of the hand in the one or more hand images, an upscaling module configured to determine, based on the hand velocity and the average jitter, an upscaling factor for generating high-resolution hand images corresponding to the captured one or more hand images, a key-point module configured to measure, using the generated high-resolution hand images, a movement of a plurality of hand key-points associated with the hand, and a gesture recognition module configured to recognize, based on a comparison of the measured movement of the plurality of hand key-points and the determined average jitter, the movement of the plurality of hand key-points as a hand micro-gesture.

To further clarify the advantages and features of the disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

Additionally, there are existing solutions in the prior art which use generative artificial intelligence to detect micro-gestures. Methods of the related art involving artificial intelligence/machine learning (AI/ML) require huge amounts of data and are calculation intensive. More specifically, the AI/ML methods require training before implementation, which in turn requires huge sample data for training.

Such methods require extensive training and are computation heavy, which tends to slow down the VST devices. Further, if the micro-gestures are not detected and recognized correctly by the VST device, the user may have to keep on repeating the same and this may be tiring and frustrating for the user.

In accordance with an aspect of the disclosure, one or more non-transitory computer readable storage media storing one or more computer programs including computer-executable instructions that, when executed individually or collectively by a processor of a visual see through (VST) device for hand micro-gesture recognition, cause the VST device to perform operations are provided. The operations include determining a hand velocity of a movement of a hand of a user using one or more hand images being captured by the VST device, determining an average jitter associated with the movement of the hand in the one or more hand images, determining, based on the hand velocity and the average jitter, an upscaling factor to generate high-resolution hand images corresponding to the captured one or more hand images, generating the high-resolution hand images by increasing, as per the upscaling factor, a resolution of the corresponding captured one or more hand images, measuring, using the generated high-resolution hand images, a movement of a plurality of hand key-points associated with the hand, and recognizing, based on a comparison of the measured movement of the plurality of hand key-points and the determined average jitter, the movement of the plurality of hand key-points as a hand micro-gesture.

Therefore, in view of the above-mentioned problems, it is advantageous to provide an improved system and method that can overcome the above-mentioned problems and limitations.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a scenario depicting a real-world scene being captured using a visual see through (VST) device according to the related art;

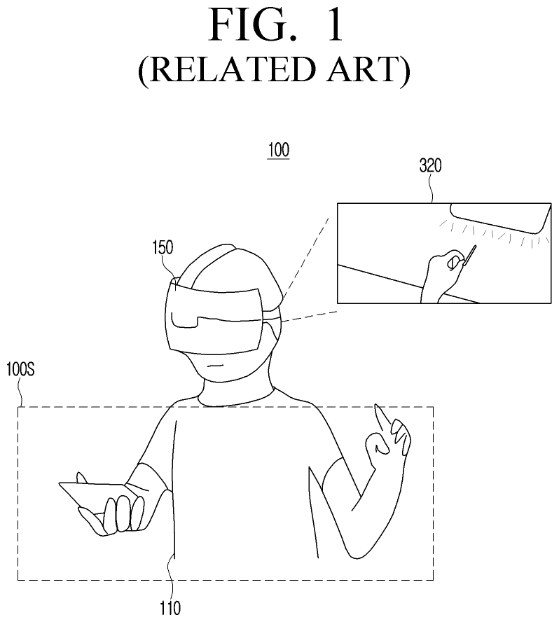

FIG. 2 illustrates micro-gestures according to the related art;

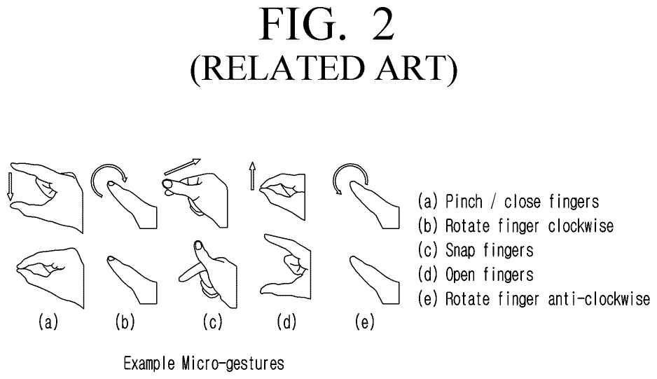

FIG. 3 illustrates an environment comprising a system for recognition of a hand micro-gesture for the VST device according to an embodiment of the disclosure;

FIG. 4 illustrates the system for recognition of a hand micro-gesture made by a user according to an embodiment of the disclosure;

FIG. 5 illustrates a process flow of the system for recognition of the hand micro-gesture made by the user according to an embodiment of the disclosure;

FIG. 6A illustrates a process flow of a jitter module of the system according to an embodiment of the disclosure;

FIG. 6B illustrates a graph comparing an estimated trajectory and a predicted trajectory for each key point of a hand of a user according to an embodiment of the disclosure;

FIG. 7 illustrates a table showing values of an upscaling factor as calculated using an upscaling module of the system according to an embodiment of the disclosure;

FIG. 8 illustrates a process flow for the working of the upscaling module according to an embodiment of the disclosure;

FIG. 9 illustrates a comparison of an input frame and an output frame of the upscaling module according to an embodiment of the disclosure;

FIG. 10A illustrates a process flow for the working of a key-point module and a gesture recognition module of the system according to an embodiment of the disclosure;

FIG. 10B illustrates a set of pre-defined recognized hand micro-gestures according to an embodiment of the disclosure; and

FIG. 11 is a flowchart illustrating a method for the hand micro-gesture recognition for the VST device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “some” or “one or more” as used herein is defined as “one”, “more than one”, or “all.” Accordingly, the terms “more than one,” “one or more” or “all” would all fall under the definition of “some” or “one or more”. The terms “an embodiment”, “another embodiment”, “some embodiments”, or “in one or more embodiments” may refer to one embodiment or several embodiments of the disclosure, or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein, such as but not limited to “includes,” “comprises,” “has,” “consists,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “mush comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language, such as “there needs to be one or more” or “one or more element is required.”

Unless otherwise defined, all terms, and especially any technical and/or scientific terms, used herein may be taken to have the same meaning as commonly understood by one having ordinary skill in the art.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

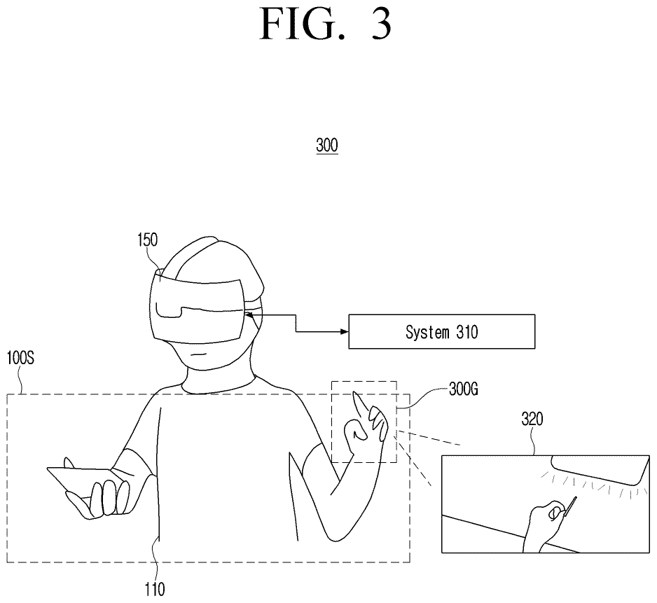

FIG. 3 illustrates an environment 300 comprising a system 310 for recognition of a hand micro-gesture 300G for a visual see through (VST) device 150 according to an embodiment of the disclosure.

Referring to FIG. 3, the hand micro-gesture 300G is captured by the VST device 150 (interchangeably referred to herein as the device 150). The user 110 makes the hand micro-gesture 300G in a predefined pattern recognizable by the device 150 as an input. Examples of the hand micro-gesture 300G may include pinching/closing fingers, rotating fingers clockwise, snapping fingers, opening fingers, rotating finger anti-clockwise, and the like. The hand micro-gesture 300G may be configurable for the device 150. For example, a special specific movement of the hand may be added as a new micro hand gesture to input a command into the device 150.

The system 310 is communicably coupled with the device 150 for recognition of the hand micro-gesture 300G made by the user 110. In an embodiment of the disclosure, the system 310 may be located in the device 150. In another embodiment of the disclosure, the system 310 is in the form of programmed instructions and may be located at distributed locations such as within the operating system of device 150, installed externally as a software application on the device 150 or in cloud. In another embodiment of the disclosure, the system 310 may be located on a server in communication with the device 150.

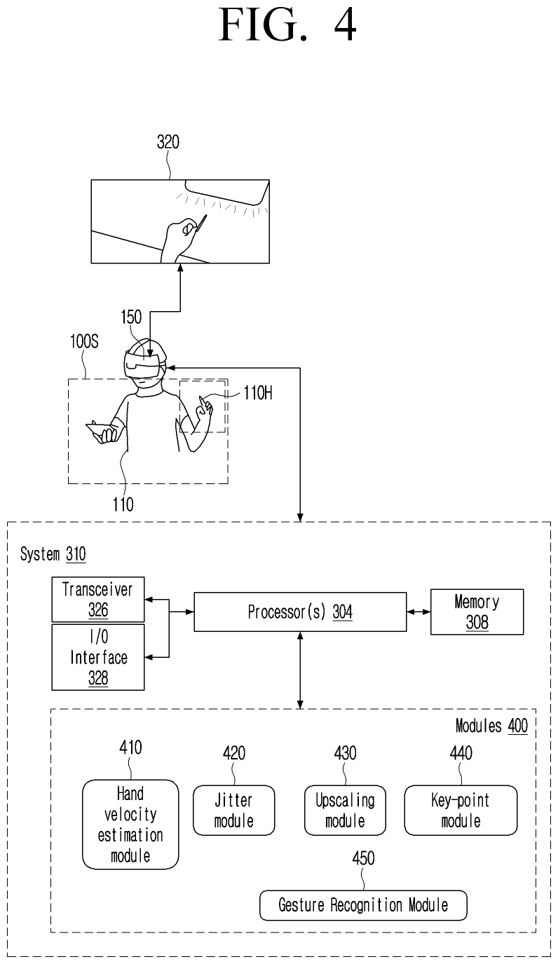

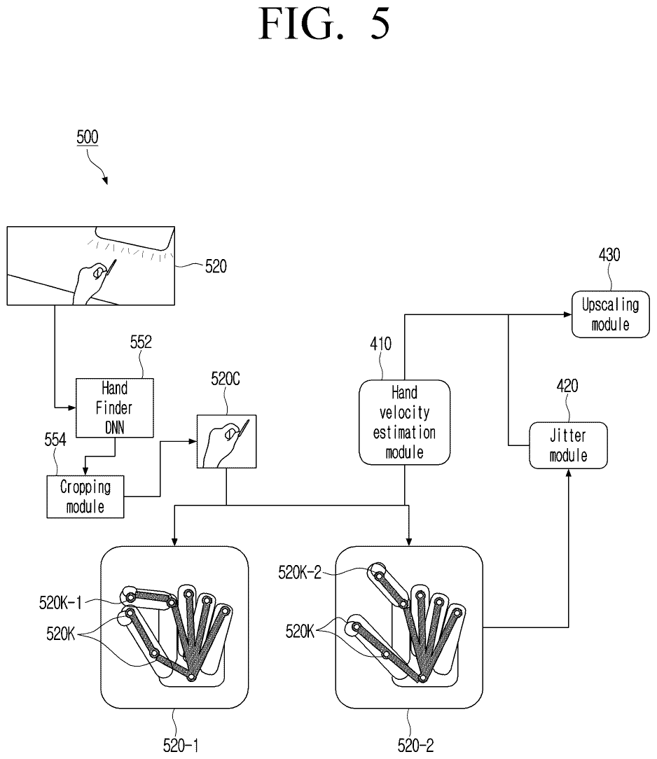

In such embodiments of the disclosure, the device 150 may include multiple layers, for example, an application layer, a file system layer, or the like. The application layer may include a video player application, a gallery application, or a camera application, without departing from the scope of the disclosure. Further, the file system layer may include a file reader, a CoDec, and a frame data. The file reader may be configured to read a video recorded by the application layer. The CoDec detects/checks the format of the recorded video (file) and also checks the coder-decoder part of the format of the file. Further, the frame data is prepared/formed by the CoDec for rendering a plurality of frames associated with the video on the display of the device 150. Further details of the system 310 are explained in conjunction with at least FIGS. 4 and 5.

FIG. 4 illustrates a system 310 for recognition of a hand micro-gesture 300G made by a user 110 according to an embodiment of the disclosure.

Referring to FIG. 4, the system 310 includes a plurality of modules 400 including a hand velocity estimation module 410, a jitter module 420, an upscaling module 430, a key-point module 440 and a gesture recognition module 450. The hand velocity estimation module 410 is configured for determining a hand velocity of a movement of a hand 110H of the user 110 using one or more hand images 320 being captured by the device 150. Subsequently, the jitter module 420 is configured for determining an average jitter associated with the movement of the hand 110H in the one or more hand images 320. Further, the upscaling module 430 is configured for determining an upscaling factor for generating high-resolution hand images corresponding to the captured one or more hand images 320. The upscaling module 430 is configured for determining the upscaling factor based on the determined hand velocity and the determined average jitter. Using the generated high-resolution hand images, the key-point module 440 is configured for measuring a movement of a plurality of hand key-points associated with the hand 110H. Based on a comparison of the measured movement of the plurality of hand key-points and the determined average jitter, the gesture recognition module 450 is configured for recognizing the movement of the plurality of hand key-points as a hand micro-gesture.

In an embodiment of the disclosure, the system 310 includes a processor 304, memory 308, a transceiver 326 and an input/output (I/O) interface 328. The processor 304 may be disposed in communication with a communication network via a network interface. In an embodiment of the disclosure, the network interface may be the I/O interface 328. In an embodiment of the disclosure, the network interface may connect to the communication network to enable the connection of the system 310 with the device 150. The network interface may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, or the like. The communication network may include, without limitation, a direct interconnection, local area network (LAN), wide area network (WAN), wireless network (e.g., using wireless application Protocol), the Internet, or the like. Using the network interface and the communication network, the system 310 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 702.11a/b/g/n/x, or the like.

In some embodiments of the disclosure, the memory 308 may be communicatively coupled to the processor 304. The memory 308 may be configured to store data, and instructions executable by the processor 304. In one embodiment of the disclosure, the memory 308 may be provided within the device 150. In another embodiment of the disclosure, the memory 308 may be provided within the system 310 being remote from the device 150. In yet another embodiment of the disclosure, the memory 308 may communicate with the processor 304 via a bus within the system 310. In yet another embodiment of the disclosure, the memory 308 may be located remotely from the processor 304 and may be in communication with the processor 304 via a network. The memory 308 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 308 may include a cache or random-access memory for the processor 304. In alternative examples, the memory 308 is separate from the processor 304, such as cache memory of a processor, the system memory, or other memory. The memory 308 may be an external storage device or database for storing data. The memory 308 may be operable to store instructions executable by the processor 304. The functions, acts, or tasks illustrated in the figures or described may be performed by the programmed processor 304 for executing the instructions stored in the memory 308. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

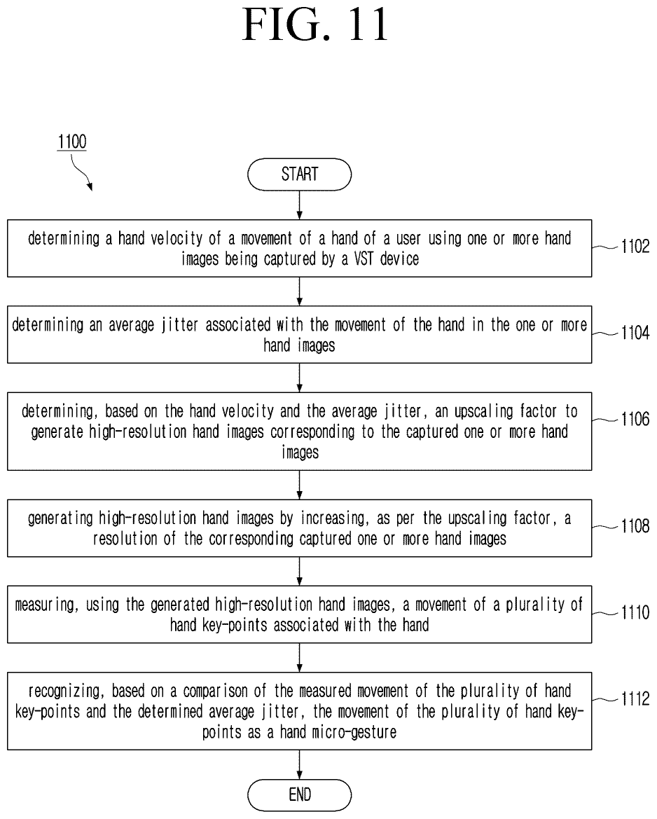

In some embodiments of the disclosure, the plurality of modules 400 may be included within the memory 308. The plurality of modules 400 may include a set of instructions that may be executed to cause the system 310, in particular, the processor 304 of the system 310, to perform any one or more of the methods/processes disclosed herein. The plurality of modules 400 may be configured to perform the steps of the disclosure using the data stored in the database. For instance, the plurality of modules 400 may be configured to perform the steps disclosed with reference to FIG. 11.

In an embodiment of the disclosure, each of the plurality of modules 400 may be a hardware unit which may be outside the memory 308. Further, the memory 308 may include an operating system for performing one or more tasks of the system 310, as performed by a generic operating system. Each of the modules 400 may be in communication with one another and the processor 304.

At least one of the plurality of modules 400 may be implemented through an artificial intelligence (AI) model. A function associated with the AI model may be performed through the non-volatile memory, the volatile memory, and the processor 304.

The processor 304 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or the AI model stored in the non-volatile memory and the volatile memory. The predefined operating rule or the AI model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method of an electronic device, a method for generating a plurality of instructions for enhancing motor skills of a user may use an AI model to recommend/execute the plurality of instructions by using sensor data. The processor may perform a pre-processing operation on the data to convert into a form appropriate for use as an input for the AI model. The AI model may be obtained by training. Here, “obtained by training” means that a predefined operation rule or AI model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation.

The working and functioning of the plurality of modules 400 of the system 310 have been described with reference to the following Figures.

FIG. 5 illustrates a process flow 500 of a system for hand micro-gesture recognition according to an embodiment of the disclosure.

Referring to FIG. 5, the device 150 captures images 520 including a current frame 520-1 and a previous frame 520-2 of the hand 110H of the user 110. In an embodiment of the disclosure, the system 310 includes a hand finder DNN for locating the hand 110H in the captured hand images 520. The system 310 further includes a cropping module 554 configured for cropping the captured hand images 520 to generate cropped hand images 520C.

The hand velocity estimation module 410 is configured for determining a displacement for each of the plurality of hand key-points 520K in the captured hand images 520. In an embodiment of the disclosure, the hand velocity estimation module 410 may use machine learning (ML) models capable of predicting locations of the plurality of hand key-points 520K in the captured hand images 520.

The hand velocity estimation module 410 is further configured for correlating the displacement and a frame-rate of the captured hand images 520. A key-point velocity for each of the hand key-points 520K is determined based on the correlation. For example, the displacement for the movement of the hand key-point 520K-1 in the current frame 520-1 to the hand-key point 520K-2 in the previous frame 520-2 is calculated and correlated with the time difference between the capturing of the current frame 520-1 and the previous frame 520-2 to determine the key-point velocity for the hand key point 520K-1. Similarly, the key-point velocity for each hand key point 520K is determined by the hand velocity estimation module 410.

Based upon the key-point velocity for each hand key point 520K, the hand velocity estimation module 410 is further configured for determining an average of the key-point velocities of the plurality of hand key-points 520-K as the hand velocity of the hand 110H.

In an embodiment of the disclosure, the movement in the key-point 520K-1 may be represented by a Euclidian distance in the three dimensional (3D) space:

$$Keypoint movement = \sqrt{{( {x}_{N} - {x}_{N - 1} )}^{2} + {( {y}_{N} - {y}_{N - 1} )}^{2} + {( {z}_{N} - {z}_{N - 1} )}^{2}}$$

Where,
(x_{N}, y_{N}, z_{N}) & (x_{N-1}, y_{N-1}, z_{N-1}) are the estimated key-point position in Nth and (N−1)th frame respectively.

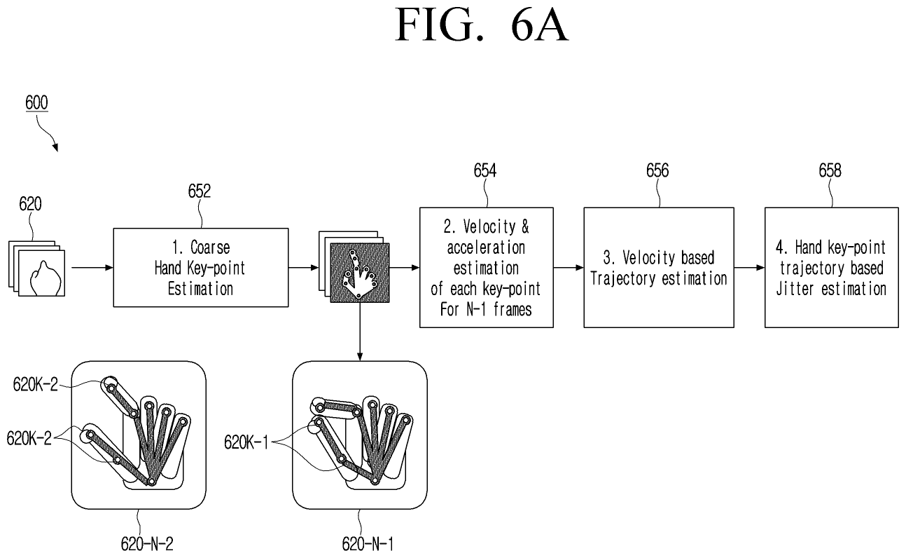

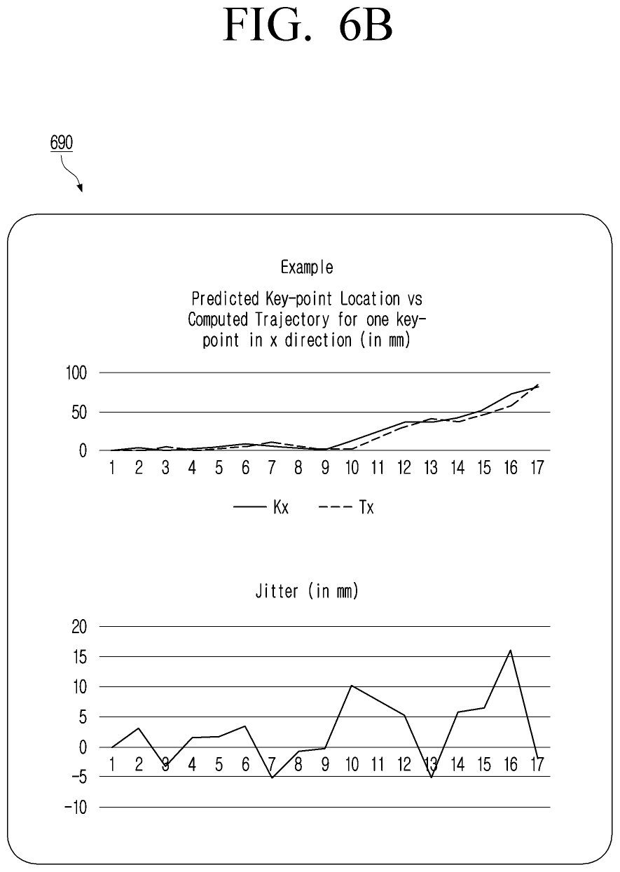

FIG. 6A illustrates a process flow 600 of a jitter module of a system according to an embodiment of the disclosure.

Referring to FIG. 6A, the jitter module 420 is configured for performing a coarse hand key-point estimation for the plurality of hand key-points 620-K (620-K−2 and 620-K−1) hand key-points 620-K in a plurality of frames 620 of the captured hand images 520. The plurality of frames 620 includes a set of frames including 620N−1, 620N−2, 620N−3 and so on. The coarse hand key-point estimation is performed for predicting a trajectory of the hand key-points 620-K. In an embodiment of the disclosure, the jitter module 420 uses ML models to perform the hand key-point estimation. In an embodiment of the disclosure, the jitter module 430 is configured for detecting a coarse hand key-point location for each of the plurality of hand key-points using an ML model.

The jitter module 420 is further configured for estimating a velocity and an acceleration for each of the plurality of hand key-points 620-K. The velocity and an acceleration are estimated by correlating a displacement of the coarse hand key-points 620-K in the plurality of frames 620 and the frame-rate of capturing the plurality of frames 620. The jitter module 420 is configured for correlating the displacement of the coarse hand key-points 620-K−1 of a current frame 620-N−1 and the coarse key-point 620-K−2 of a previous frame 620-N−2 and a time elapsed between the capturing of the current frame 620-N−1 and the previous frame 620-N−2.

The jitter module 420 is further configured for estimating a trajectory for each of the plurality of hand key-points 620-K based on the estimated velocity, the estimated acceleration and the coarse hand key-point 620-K estimation. Subsequently, the jitter module 420 is further configured for calculating the average jitter based on the estimated trajectory and the predicted trajectory. The jitter module 420 is configured for calculating a trajectory difference value by comparing the estimated trajectory for each key-point and the predicted trajectory for each key-point. Further, an average of the trajectory difference values is calculated for the plurality of hand key-points as the average jitter.

FIG. 6B illustrates a graph 690 comparing an estimated trajectory and a predicted trajectory for each key-point 620-K according to an embodiment of the disclosure.

Referring to FIG. 6B, the working of the jitter module 420 may be explained with the reference to the following example with reference to FIG. 6A:
652: Let Kᵢ^{j}(x,y,z) be the detected i^{th} coarse key-point location for frame j
654: Let Vᵢ^{j}, Aᵢ^{j} be the velocity & acceleration of Kᵢ key-point at frame J and F be the frame rate (represented as frames per second):

$${V}_{i}^{J} ( {v}_{{x}_{i}}^{J} , {v}_{{y}_{i}}^{J} , {v}_{{z}_{i}}^{J} ) = F * ( ( {x}_{i}^{j} - {x}_{i}^{j - 1} ) , ( {y}_{i}^{j} - {y}_{i}^{j - 1} ) , ( {z}_{i}^{j} - {z}_{i}^{j - 1} ) )$$

$${A}_{i}^{J} ( {a}_{{x}_{i}}^{J} , {a}_{{y}_{i}}^{J} , {a}_{{z}_{i}}^{J} ) = F * ( ( {v}_{{x}_{i}}^{j} - {v}_{{x}_{i}}^{j - 1} ) , ( {v}_{{y}_{i}}^{j} - {v}_{{y}_{i}}^{j - 1} ) , ( {v}_{{z}_{i}}^{j} - {v}_{{z}_{i}}^{j - 1} ) )$$

656: Let, Ti be the trajectory position of Kᵢ key-point at frame J:

$${T}_{i}^{J} ( {x}_{i}^{J} , {y}_{i}^{J} , {z}_{i}^{J} ) = {T}_{i}^{J - 1} + ( ( \frac{{v}_{{x}_{i}}^{J}}{F} + \frac{1}{2} \frac{{a}_{{x}_{i}}^{J - 1}}{F * F} ) , ( \frac{{v}_{{y}_{i}}^{J}}{F} + \frac{1}{2} \frac{{a}_{{y}_{i}}^{J - 1}}{F * F} ) , ( \frac{{v}_{{y}_{i}}^{J}}{F} + \frac{1}{2} \frac{{a}_{{z}_{i}}^{J - 1}}{F * F} ) )$$

658: Average Jitter AJ for I key-points at frame J is given by:

$$A J = \frac{1}{I} {\sum }_{i = 0}^{I} \vert {T}_{i}^{J} - {K}_{i}^{J} \vert$$

The system 310 uses the estimated velocity and the estimated acceleration of each key-point 620-K to determine a next position of the key-point 620-K to plot a trajectory for the corresponding key-point 620-K.

Referring to FIG. 6B, the predicted trajectory tries to fix the position by ignoring the jitter in the hand movement. Thus, a deviation from the trajectory may be considered as a jitter when the key-point 620-K comes back closer to the trajectory in the next frame 620-N.

Subsequently, the system 310 uses the determined hand velocity and the determined average jitter to calculate the upscaling factor. The upscaling factor is used for increasing the resolution of the captured hand images 520 before measuring the movement of the hand key-points 520K.

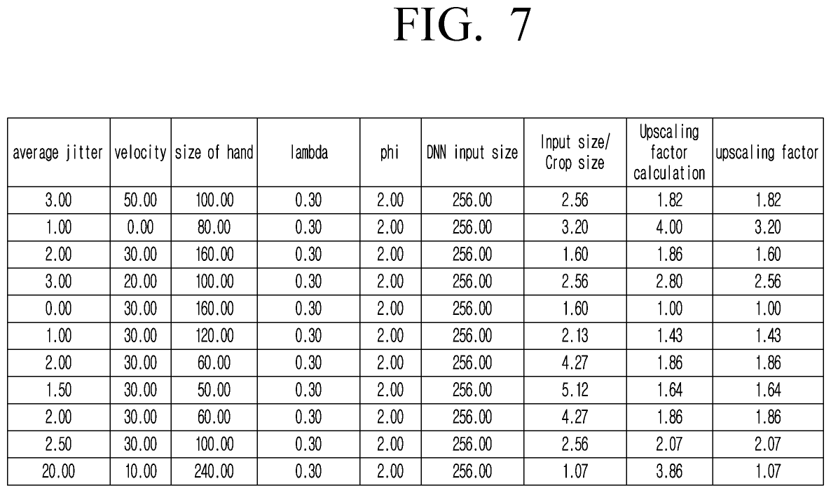

FIG. 7 illustrates a table 700 illustrates values of an upscaling factor as calculated using a upscaling module according to an embodiment of the disclosure.

Referring to FIG. 7, the upscaling module 430 is configured for determining the upscaling factor by taking a minima value from a set consisting of a first value obtained by correlating the determined average jitter and the determined hand velocity and a second value obtained by correlating a predefined input size of the captured hand images 520 to the ML models and a size of cropped hand images 520C.

A relationship for determining the upscaling factor may be represented as:

$$Upscaling factor ( ψ ) = min ( \frac{λ * Avergage jitter ( in mm )}{( 1 + ϕ * Velocity of hand ( in \frac{mm}{s} ) )} + 1 , \frac{DNN input size ( in pxl )}{Size of hand crop ( in pxl )} )$$

Where,
λ and φ are constants based on the units of measurement being used.

In an embodiment of the disclosure, the upscaling factor is directly proportional to the jitter as calculated by the jitter module 420. The higher the jitter, the higher the upscaling factor. The upscaling factor may be inversely proportional to the determined hand velocity since when the hand is moving quickly, there is very less probability of happening of a micro-gesture. Thus, upscaling required to detect a micro-gesture may not be required. The upper limit for the upscaling factor is the ratio of captured hand images 520 to the size of cropped hand images 520C.

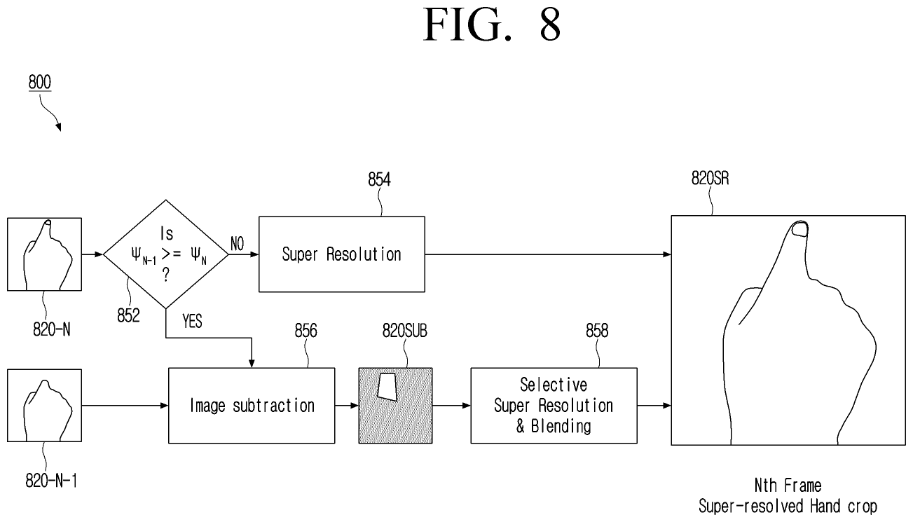

FIG. 8 illustrates a process flow 800 for a working of an upscaling module according to an embodiment of the disclosure.

Referring to FIG. 8, the upscaling module 430 is configured for generating high-resolution hand images 820SR based on a comparison between a current upscaling factor for a current frame 820-N and a previous upscaling factor of a previous frame 820-N−1 of the captured hand images 520. At 852, the upscaling module 430 is configured to compare whether the previous upscaling factor is greater than the current upscaling factor. If the condition is satisfied, the upscaling module 430 is configured to perform image subtraction at 856 between the current frame 820-N and the previous frame 820-N−1 to obtain a difference portion image 820-SUB. Subsequently, at 858, the upscaling module 430 is configured to apply the previous upscaling factor to the difference portion image 820SUB for increasing a resolution of the difference portion image 820SUB using a super resolution module. Finally, the upscaling module 430 is configured to blend the increased resolution difference portion image with the previous frame 820N−1 to generate the high-resolution hand image 820SR.

Alternatively, if the condition at 852 is not satisfied and the previous upscaling factor is not greater than the current upscaling factor, the current upscaling factor is applied. The upscaling module 430 is configured to perform super resolution at 854 on the current frame 820-N using the super resolution module. It may be appreciated that based on the comparison of the previous upscaling factor and the current upscaling factor, the system 310 uses the previous frame 820-N−1 to reduce the area for applying the super resolution and thus save on computational load.

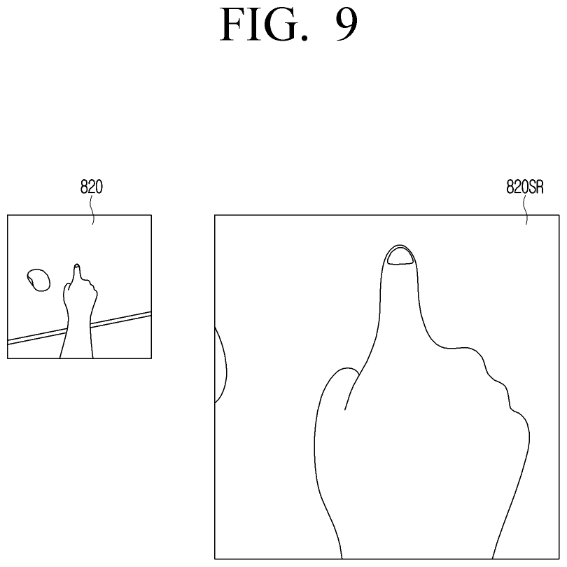

FIG. 9 illustrates a comparison of an input frame 820 and an output frame of an upscaling module according to an embodiment of the disclosure.

Referring to FIG. 9, the high-resolution hand images 820SR is used for estimation of the hand key-points 520K by the key-point module 440. It may be appreciated that the high-resolution hand images 820SR being high resolution and cropped adds to the optimization of the use of resources of the device 150.

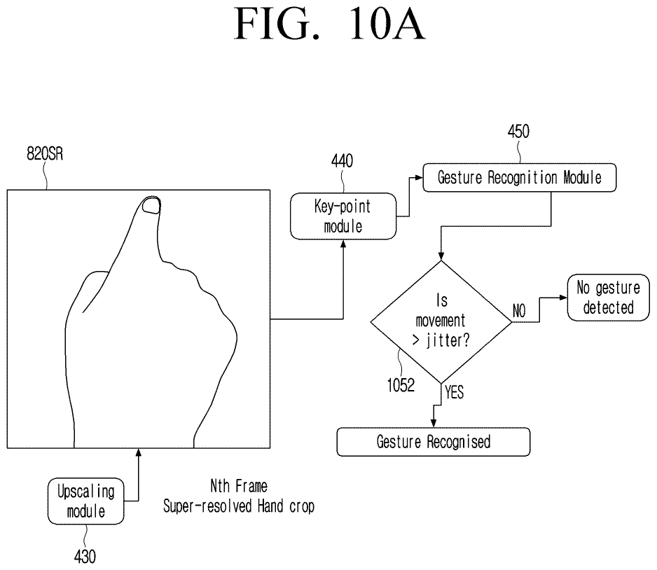

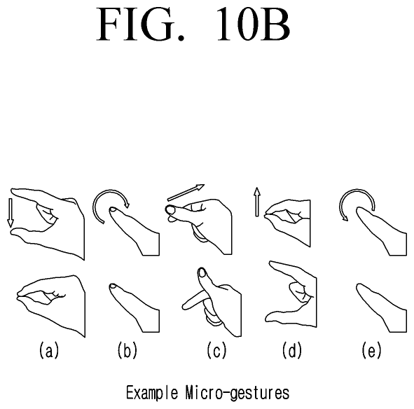

FIG. 10A illustrates a process flow 1000 for a working of a key-point module and a gesture recognition module according to an embodiment of the disclosure.

Referring to FIG. 10A, the key-point module 440 is configured for measuring the movement of each of the plurality of hand key-points 520K using the generated high-resolution hand images 820SR. The gesture recognition module 450 is configured for recognizing the movement of the plurality of hand key-points 520K as a hand micro-gesture based on the comparison of the measured movement of the plurality of hand key-points 520K and the determined average jitter. At 1052, the system 310 is configured to compare and determined if the movement of the key points 520K is greater than the determined average jitter value. If the condition is satisfied, the gesture recognition module 450 is configured for recognizing the movement of the plurality of hand key-points 520K as the hand micro-gesture. Further, the gesture recognition module 450 is configured for identifying the measured movement of the key points 520K as a recognized hand micro-gesture. More precisely, the gesture recognition module 450 is configured for identifying the hand micro-gesture as one of a recognized hand micro-gestures based upon a comparison with a set of pre-defined recognized hand micro-gestures.

FIG. 10B illustrates a set of pre-defined recognized hand micro-gestures according to an embodiment of the disclosure.

Referring to FIG. 10B, a certain command may be associated with each of the hand micro-gestures. In an embodiment of the disclosure, the command or input associated with the hand micro-gesture is configurable for the device 150. Specifically, FIG. 10B shows:
(a) Pinching/closing fingers
(b) Rotating finger clockwise
(c) Snapping fingers
(d) Opening fingers
(e) Rotating finger anti-clockwise

FIG. 11 is a flowchart illustrating a method 1100 for hand micro-gesture recognition for a visual see through (VST) device according to an embodiment of the disclosure.

Referring to FIGS. 3, 4, 5, 6A, 6B, 7, 8, 9, 10A, and 10B together, the method 1100 may be performed by the device 150 such as a camera device having image capturing capabilities, e.g., a camcorder, a mobile device, a tab with similar capabilities, and the like, based on instructions retrieved from non-transitory computer-readable media. A computer-readable media may include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1100 includes a series of operations shown at operation 1102 through operation 1112 of FIG. 11. The method 1100 may be performed by the system 310 in conjunction with one or more modules 400, the details of which are explained in conjunction with FIGS. 3, 4, 5, 6A, 6B, 7, 8, 9, 10A, and 10B, and the same are not repeated here for the sake of brevity. The method 1100 begins at operation 1102.

At operation 1102, the method 1100 includes determining a hand velocity of a movement of a hand 110H of the user using one or more hand images 520 being captured by the device 150. In an embodiment of the disclosure, the method 1100, at operation 1102 further includes determining, using a machine learning (ML) model capable of predicting locations of the plurality of hand key-points 520K, a displacement for each of the plurality of hand key-points 520K. Further, the method at operation 1102 includes correlating the displacement of each of the hand key-point 520K and a frame-rate of the captured hand images 520 for determining a corresponding key-point velocity. Finally, at operation 1102, the method 1100 includes determining an average of the determined key-point velocities of the plurality of hand key-points as the hand velocity.

At operation 1104, the method 1100 includes determining an average jitter associated with the movement of the hand in the one or more hand images. In an embodiment of the disclosure, at operation 1104, the method 1100 includes using machine learning (ML) models for performing a coarse hand key-point estimation for the plurality of hand key-points 520K for predicting a trajectory of the hand key-points 520K. In an embodiment of the disclosure, at operation 1104, the method 1100 may include detecting a coarse hand key-point location for each of the plurality of hand key-points using ML models. The method 1100, at operation 1104 further includes estimating a velocity and an acceleration for each of the plurality of hand key-points 520K by correlating a displacement of the coarse hand key-points 520K and the frame-rate of capturing for the captured hand images 520. The method 1100 further includes correlating the displacement of the coarse hand key-points 520K between a current frame such as the frame 520-1 and a previous frame such as the frame 520-2 of the plurality of frames and a time elapsed between the capturing of the current frame 520-1 and the previous frame 520-2 for estimating the velocity and acceleration.

Further, the method 1100 at operation 1104 includes estimating a trajectory for each of the plurality of hand key-points 520K based on the estimated velocity, the estimated acceleration and the coarse hand key-point estimation. Finally, at operation 1104, the average jitter associated with the movement of the hand 110H is calculated based on the estimated trajectory and the predicted trajectory.

Furthermore, the method 1100 at operation 1106 includes determining an upscaling factor to generate high-resolution hand images 820SR corresponding to the captured one or more hand images 520. Determining the upscaling factor at operation 1106 includes taking a minima from a set consisting of a first value obtained by correlating the average jitter and the hand velocity and a second value obtained by correlating a predefined input size to an ML model and a size of cropped hand images 520C of the captured hand images 520.

Furthermore, the method 1100 at operation 1108 includes generating high-resolution hand images 820SR by increasing a resolution of the corresponding captured one or more hand images 520 as per the upscaling factor. In an embodiment of the disclosure, the method 1100 further includes using super resolution for increasing the resolution of only a subset of images from the captured hand images 520. In an embodiment of the disclosure, the method 1100 further includes cropping the captured hand images 520 to generate cropped hand images 520C. At operation 1108, the method 1100 further includes comparing a current upscaling factor for a current frame 820-N and a previous upscaling factor of a previous frame 820-N−1 of the captured hand images 520. Further, operation 1108 includes comparing whether the previous upscaling factor is greater than the current upscaling factor. If the condition is satisfied, the method 1100 includes performing image subtraction between the current frame 820-N and the previous frame 820-N−1 to obtain a difference portion image 820-SUB. Subsequently, the method 1100 at operation 1108 includes applying the previous upscaling factor to the difference portion image 820SUB for increasing a resolution of the difference portion image 820SUB using super resolution. Finally, the method includes blending the increased resolution difference portion image 820SUB with the previous frame 820N−1 to generate the high-resolution hand image 820SR.

In operation 1110, the method 1100 further includes recognizing the movement of the plurality of hand key-points 520K as the hand micro-gesture when the measured movement of the plurality of hand key-points is more than the determined average jitter. In an embodiment of the disclosure, the method 1100 further includes identifying the measured movement as the recognized hand micro-gesture based upon a comparison with a set of pre-defined recognized hand micro-gestures.

Hence, the system 310 and the method 1100 is directed at accurate detection and recognition of hand micro-gestures enabling smooth and easy user experience. Because of the improvement in the recognition and accuracy of the hand gestures, the user is not required to unnecessarily repeat the hand micro-gestures. The system 310 and method 1100 of the disclosure is advantageous since by applying super resolution and using the cropped hand images, optimum utilization of the resources of the device 150 is achieved. Since the upscaling factor is inversely proportional to the hand velocity, the resource usage is high when the hand is static as compared to when the hand is moving fast. As a result, the disclosure achieves optimum utilization of resources of the device 150. The disclosure can be adapted for use with any HMD/extended reality (XR)/AR device where hand gestures is a form of interaction with the device.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A system for hand micro-gesture recognition for a visual see through (VST) device, the system comprising:
a hand velocity estimation module configured to determine a hand velocity of a movement of a hand of a user using one or more hand images being captured by the VST device;
a jitter module configured to determine an average jitter associated with the movement of the hand in the one or more hand images;
an upscaling module configured to determine, based on the hand velocity and the average jitter, an upscaling factor for generating high-resolution hand images corresponding to the captured one or more hand images;
a key-point module configured to measure, using the generated high-resolution hand images, a movement of a plurality of hand key-points associated with the hand; and
a gesture recognition module configured to recognize, based on a comparison of the measured movement of the plurality of hand key-points and the determined average jitter, the movement of the plurality of hand key-points as a hand micro-gesture.

2. The system of claim 1, wherein the gesture recognition module is further configured to recognize the movement of the plurality of hand key-points as the hand micro-gesture when the measured movement of the plurality of hand key-points is more than the determined average jitter.

3. The system of claim 1, wherein the gesture recognition module is further configured to identify, based upon a comparison with a set of pre-defined recognized hand micro-gestures, the measured movement as a recognized hand micro-gesture.

4. The system of claim 1, wherein the system comprises a super resolution module configured to increase the resolution, based on the upscaling factor, of only a subset of images from the captured hand images.

5. The system of claim 4, wherein the system comprises a cropping module configured to crop the captured hand images to generate cropped hand images.

6. The system of claim 1, wherein the hand velocity estimation module is further configured to:
determine, using a machine learning (ML) model capable of predicting locations of the plurality of hand key-points, a displacement for each of the plurality of hand key-points in the captured hand images,
correlate, for each of the plurality of hand key-points, the displacement of the hand key-point and a frame-rate of the captured hand images for determining a key-point velocity, and
determine an average of the key-point velocities of the plurality of hand key-points as the hand velocity.

7. The system of claim 1, wherein the jitter module is further configured to:
perform a coarse hand key-point estimation, using an ML model, for the plurality of hand key-points for predicting a trajectory of the hand key-points,
estimate, for each of the plurality of hand key-points, a velocity and an acceleration by correlating a displacement of the coarse hand key-points in a plurality of frames of the captured hand images and a frame-rate of the captured hand images,
estimate a trajectory, for each of the plurality of hand key-points, based on the estimated velocity, the estimated acceleration and the coarse hand key-point estimation, and
calculate the average jitter based on the estimated trajectory and the predicted trajectory.

8. The system of claim 7, wherein the jitter module is further configured to detect a coarse hand key-point location for each of the plurality of hand key-points using an ML model.

9. The system of claim 7, wherein the jitter module is further configured to correlate:
the displacement of the coarse hand key-points between a current frame and a previous frame of the plurality of frames; and
a time elapsed between the capturing of the current frame and the previous frame by the VST device.

10. The system of claim 7, wherein the jitter module is further configured to:
calculate, for each of the plurality of hand key-points, a trajectory difference value by comparing the estimated trajectory for each key-point and the predicted trajectory for each key-point, and
calculate an average of the trajectory difference values, for the plurality of hand key-points, as the average jitter.

11. The system of claim 1, wherein the upscaling module is further configured to take a minima from a set consisting of:
a first value obtained by correlating the average jitter and the hand velocity; and
a second value obtained by correlating a predefined input size of the captured hand images to an ML model and a size of cropped hand images of the captured hand images.

12. The system of claim 1, wherein the upscaling module is further configured to generate the high-resolution hand images based on a comparison between a current upscaling factor for a current frame and a previous upscaling factor of a previous frame of the captured hand images.

13. The system of claim 1, wherein the upscaling module is further configured to:
compare a current upscaling factor of a current frame of the captured hand images with a previous upscaling factor of a previous frame of the captured hand images,
perform, based upon the comparison, image subtraction between the current frame and the previous frame to obtain a difference portion image,
apply the previous upscaling factor to the difference portion image for increasing a resolution of the difference portion image using super resolution, and
blend the increased resolution difference portion image with the previous frame to generate the high-resolution hand image.

14. A method for hand micro-gesture recognition for a visual see through (VST) device, the method comprising:
determining a hand velocity of a movement of a hand of a user using one or more hand images being captured by the VST device;
determining an average jitter associated with the movement of the hand in the one or more hand images;
determining, based on the hand velocity and the average jitter, an upscaling factor to generate high-resolution hand images corresponding to the captured one or more hand images;
generating the high-resolution hand images by increasing, as per the upscaling factor, a resolution of the corresponding captured one or more hand images;
measuring, using the generated high-resolution hand images, a movement of a plurality of hand key-points associated with the hand; and
recognizing, based on a comparison of the measured movement of the plurality of hand key-points and the determined average jitter, the movement of the plurality of hand key-points as a hand micro-gesture.

15. The method of claim 14, further comprising:
recognizing the movement of the plurality of hand key-points as the hand micro-gesture when the measured movement of the plurality of hand key-points is more than the determined average jitter.

16. The method of claim 14, further comprising:
identifying, based upon a comparison with a set of pre-defined recognized hand micro-gestures, the measured movement as a recognized hand micro-gesture.

17. The method of claim 14, further comprising:
increasing the resolution, based on the upscaling factor, of only a subset of images from the captured hand images.

18. The method of claim 17, further comprising:
cropping the captured hand images to generate cropped hand images.

19. One or more non-transitory computer readable storage media storing one or more computer programs including computer-executable instructions that, when executed individually or collectively by a processor of a visual see through (VST) device for hand micro-gesture recognition, cause the VST device to perform operations, the operations comprising:
determining a hand velocity of a movement of a hand of a user using one or more hand images being captured by the VST device;
determining an average jitter associated with the movement of the hand in the one or more hand images;
determining, based on the hand velocity and the average jitter, an upscaling factor to generate high-resolution hand images corresponding to the captured one or more hand images;
generating the high-resolution hand images by increasing, as per the upscaling factor, a resolution of the corresponding captured one or more hand images;
measuring, using the generated high-resolution hand images, a movement of a plurality of hand key-points associated with the hand; and
recognizing, based on a comparison of the measured movement of the plurality of hand key-points and the determined average jitter, the movement of the plurality of hand key-points as a hand micro-gesture.

20. The one or more non-transitory computer-readable storage media of claim 19, the operations further comprising:
recognizing the movement of the plurality of hand key-points as the hand micro-gesture when the measured movement of the plurality of hand key-points is more than the determined average jitter.
